(19) United States
(12) Patent Application Publication
(10) Pub. No.: US 2017/0233104 A1
(43) Pub. Date: Aug. 17, 2017

(54) Real Time Non-Onboard Diagnostics of Aircraft Failures

(71) Applicant: GE Aviation Systems LLC, Grand Rapids, MI (US)

(72) Inventors: Randy E. Bolling, Odessa, FL (US); Christopher Scott McGill, Riverview, FL (US); Gerard John Caron, Riverview, FL (US); Jeffrey Allen Derf, Palmetto, FL (US)

(21) Appl. No.: 15/042,502

(22) Filed: Feb. 12, 2016

(51) Int. Cl. B64F 5/00

(52) U.S. Cl. CPC B64F 5/0045; B64D 2045/0085

(57) ABSTRACT

Systems and methods for diagnosing aircraft failure are provided. In one embodiment, a method can include receiving a first set of data from an aircraft in flight indicative of a failure event associated with the aircraft. The first set of data can be indicative of at least one or more conditions associated with the aircraft. The method can include performing one or more computer-based simulations to generate one or more simulated failure events, based at least in part on the conditions. The method can include identifying one or more simulated causes associated with the simulated failure events. The method can include determining one or more potential causes of at least a portion of the failure event, based at least in part on the simulated causes. The method can include communicating a second set of data indicative of at least the potential causes, to the aircraft while it is in flight.

### FIELD OF THE INVENTION

The present subject matter relates generally to diagnosing aircraft failure, and more particularly to diagnosing aircraft failure by a non-onboard computing system.

### BACKGROUND OF THE INVENTION

Avionics systems located onboard an aircraft can attempt to detect the occurrence of an aircraft failure based on various aircraft parameters. For example, data indicative of engine operating parameters can be used to determine if one or more aircraft engine(s) are experiencing problems or have failed. However, the effectiveness of onboard diagnosis of such failures can be limited. For instance, it can be difficult to perform calculations in real-time using a computing system located onboard an aircraft due to the complexity of the diagnostic algorithms. Iterative computational approaches can increase the required processing times by orders of magnitude and can be impractical to perform using onboard avionics systems. This can lead to potential inaccuracies in failure diagnosis and ultimately hinder the flight crew members' ability to address any potential causes of aircraft failure.

BRIEF DESCRIPTION OF THE INVENTION

Aspects and advantages of embodiments of the present disclosure will be set forth in part in the following description, or may be learned from the description, or may be learned through practice of the embodiments.

One example aspect of the present disclosure is directed to a computer-implemented method of diagnosing aircraft failure. The method can include receiving, by one or more computing devices, a first set of data from an aircraft in flight indicative of a failure event associated with the aircraft. The first set of data can be indicative of at least one or more conditions associated with the aircraft during the failure event. The one or more computing devices can be remote from the aircraft. The method can include performing, by the one or more computing devices, one or more computer-based simulations to generate one or more simulated failure events. The one or more simulated failure events can be based at least in part on the one or more conditions associated with the aircraft during the failure event. The method can further include identifying, by the one or more computing devices, one or more simulated causes associated with the simulated failure events. The method can include determining, by the one or more computing devices, one or more potential causes of at least a portion of the failure event, based at least in part on the one or more simulated causes associated with the one or more simulated failure events. The method can further include communicating, by the one or more computing devices, a second set of data to the aircraft while the aircraft is in flight. The second set of data can be indicative of at least the one or more potential causes of at least the portion of the failure event.

Another example aspect of the present disclosure is directed to a ground-based system for diagnosing aircraft failure. The system can include one or more processors and one or more memory devices. The memory devices can store computer-readable instructions that when executed by the one or more processors cause the system to perform operations. The operations can include receiving a first set of data from an aircraft in flight. The first set of data can be indicative of at least one or more conditions associated with the aircraft during a failure event. The operations can further include performing one or more simulations to create one or more simulated failure events. The one or more simulated failure events can be based at least in part on the one or more conditions associated with the aircraft during the failure event. The operations can include determining one or more potential causes of at least a portion of the failure event. The one or more potential causes can be based at least in part on the one or more simulated failure events. The operations can further include communicating a second set of data to the aircraft while the aircraft is in flight. The second set of data can be indicative of at least the one or more potential causes of at least a portion of the failure event.

Yet another example aspect of the present disclosure is directed to a computer-implemented method for addressing aircraft failure. The method can include detecting, by one or more first computing devices located on an aircraft in flight, a failure event associated with one or more components of the aircraft. The method can further include sending, by the one or more first computing devices, a first set of data to one or more second computing devices that are remote from the aircraft. The first set of data can include one or more conditions associated with the aircraft during the failure event. The one or more second computing devices can be configured to perform one or more simulations to generate one or more simulated failure events based at least in part on the one or more conditions associated with the aircraft during the failure event. The method can include receiving, by the one or more first computing devices while the aircraft is in flight, a second set of data from the one or more second computing devices. The second set of data can include one or more potential causes of at least a portion of the failure event. The one or more potential causes can be based at least in part on one or more simulated causes associated with the one or more simulated failure events.

Other example aspects of the present disclosure are directed to systems, methods, aircraft, avionics systems, devices, non-transitory computer-readable media for diagnosing aircraft failure.

Variations and modifications can be made to these example aspects of the present disclosure.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an overview of an example system according to example embodiments of the present disclosure;

FIG. 2 depicts an example list according to example embodiments of the present disclosure;

FIG. 3 depicts a flow diagram of an example method according to example embodiments of the present disclosure; and

FIG. 4 depicts an example system according to example embodiments of the present disclosure.

### DETAILED DESCRIPTION OF THE INVENTION

Reference now will be made in detail to embodiments of the invention, one or more example(s) of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Example aspects of the present disclosure are directed to systems and methods for diagnosing aircraft failure. For instance, an aircraft can experience a failure event, such as an engine failure, while in-flight. The onboard computing system of the aircraft can detect the engine malfunction based, for example, on operating conditions associated with the engine. To efficiently and accurately diagnose the failure, the onboard computing system can send the conditions to a remote computing system that is separate from the aircraft. Using, for instance, a massively parallel processing configuration, the remote computing system can simulate an engine malfunction based, at least in part, on the conditions to determine potential causes of the actual engine failure. The remote computing system can the communicate the potential causes of the engine failure to the onboard computing system while the aircraft is in flight, such that the aircraft and/or its operating crew can implement a solution to address the engine failure.

More particularly, while in flight an aircraft can detect a failure event associated with the aircraft. For example, the aircraft can include an onboard computing system that receives operating conditions from various aircraft control systems. The aircraft control systems can be configured to perform various aircraft operations and control various settings and parameters associated with one or more component(s) of the aircraft. For instance, the aircraft control systems can be associated with one or more engine(s) of the aircraft and can send operating conditions (e.g., engine mode data, engine health data) to the onboard computing system. Based on such operating conditions, the onboard computing system can detect whether the aircraft is experiencing a failure event, such as an engine malfunction.

To help diagnose the failure event, the onboard computing system can send operating conditions associated with the aircraft to a remote computing system, while the aircraft is in flight. The remote computing system can include a processing architecture that is different than that of the onboard computing system. For instance, the remote computing system can include a massively parallel server, workstation, and/or supercomputer based system with multiple parallel processing nodes (e.g., each containing a microprocessor) that is configured to perform a set of coordinated computations. In this case, the parallel processing architecture can be configured to simulate the aircraft failure events to determine potential causes.

For example, the remote computing system can receive, from the aircraft in flight, a first set of data indicative of at least one or more condition(s) associated with the aircraft and/or its components during a failure (e.g., an engine malfunction). The remote computing system can perform one or more computer based simulation(s) to create one or more simulated failure event(s) based, at least in part, on the condition(s). For instance, the remote computing system can simulate a malfunction of an engine based, at least in part, on operating condition(s) associated with the engine during (and/or before) the actual malfunction.

The remote computing system can determine one or more potential cause(s) of at least a portion of the failure event based at least in part on the simulated failure event(s). For instance, based on the simulated engine malfunction, the remote computing system can determine that the actual malfunction of the engine may have been caused by, for example, low oil pressure, high oil temperature, and/or a compressor surge. The remote computing device(s) can also determine one or more probability value(s) for each of the one or more potential cause(s). The probability value(s) can, for example, be indicative of a probability and/or likeliness that the potential cause is an actual cause of the failure event (e.g., engine malfunction).

The remote computing system can determine one or more recommended solution(s) for each of the potential cause(s) of the failure event. Each of the recommended solution(s) can include a proposed course of action to alleviate at least a portion of the failure event. For example, in the case of an engine malfunction, the recommended solution(s) can propose shutting down the engine, making a precautionary landing, and/or reducing the fuel flow to the engine. In some implementations, the remote computing system can generate a list of the potential cause(s) of the failure event and/or recommended solution(s) that is organized based on probability value(s).

To help the aircraft address the failure event, the remote computing system can communicate a second set of data indicative of the potential cause(s), probability value(s), and/or recommended solution(s) to the aircraft while the aircraft is in flight. For instance, in some implementations, the second set of data can include the generated list of the potential cause(s) of the failure event, probability value(s), and/or recommended solution(s).

The onboard computing system of the aircraft can receive the second set of data and can use the information to address the failure event. In some implementations, the onboard computing system can process the second set of data to automatically implement the proposed course of action (associated with the recommended solution(s)) to alleviate, at least a portion of, the failure event. For example, the onboard computing system can send one or more command signal(s) to the aircraft control system(s) associated with a failed engine to execute a control action to reduce fuel flow to the engine in the event that a compressor surge is a potential cause of the malfunction. The command signal(s) can be sent automatically, without user input (e.g., from a flight crew member), and/or based at least in part on user input.

Additionally and/or alternatively, the onboard computing system can be configured to communicate with a display system of the aircraft to display the one or more potential cause(s) of the failure event and/or the one or more recommended solution(s). For instance, the list of potential cause(s) of the failure event, probability value(s), and/or recommended solution(s) can be displayed on a display system to help a flight crew member decide which course of action to take in order to alleviate the aircraft failure event while in flight.

The systems and methods according to example aspects of the present disclosure can diagnose aircraft failure using a powerful, remote computing system. By outsourcing the failure diagnosis while in flight, the computational resources of the onboard computing system can remain focused on the operation of the aircraft during a failure event. Moreover, the remote computing system can simulate a failure event to identify potential causes and solutions in ways that are precluded by the limitations of an onboard computing system. The remote computing system can communicate the potential causes and/or solutions in a manner that can be efficiently implemented by a distressed aircraft and/or its crew. As such, aircraft failure can be addressed in-flight, reducing the possibility of unnecessary landings prior to final destination. In this way, the systems and methods according to example aspects of the present disclosure have a technical effect of more efficiently and reliably diagnosing aircraft failure events, increasing the ability of an aircraft and/or its crew to alleviate such failure while in-flight.

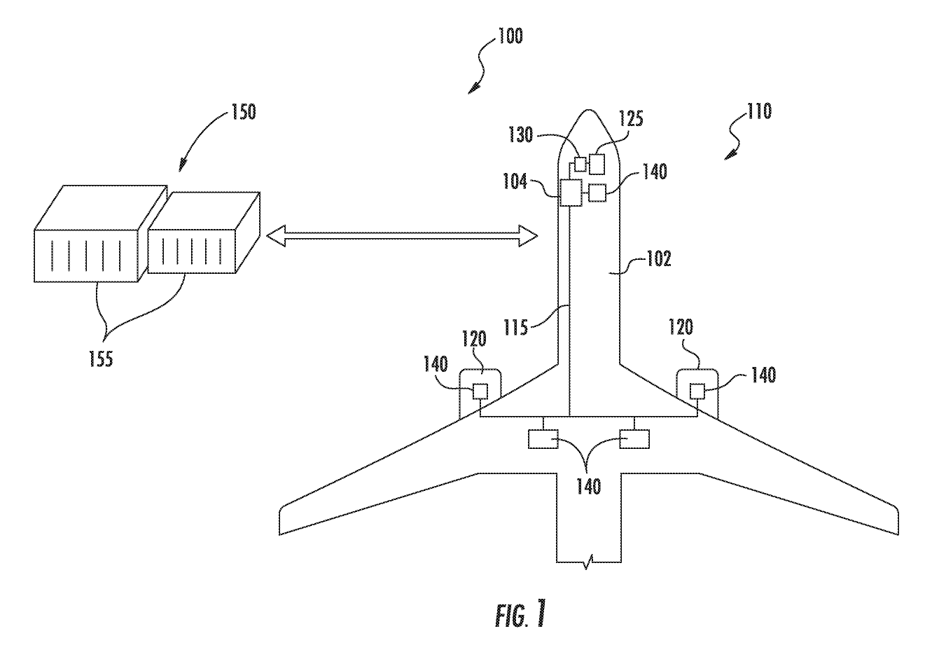

FIG. 1 depicts an example system 100 for diagnosing a failure event of an aircraft 102 according to example embodiments of the present disclosure. As shown, the system 100 can include an aircraft 102 and a computing system 150. The aircraft 102 and the computing system 150 can be configured to communicate between one another via a network such as, for example, a very high frequency (VHF) network, a high frequency (HF) network, a SATCOM network, a WiFi network, and/or any other suitable communication networks or links. In some implementations, in the event of an urgent aircraft failure event, other aircrafts and/or systems (besides the aircraft 102 and the computing system 150) can be restricted from communicating over the network to reserve bandwidth for the aircraft 102 and the computing system 150 to send and receive data.

The aircraft 102 can include an onboard computing system 110. As shown in FIG. 1, the onboard computing system 110 can include one or more onboard computing device(s) 104 that can be associated with, for instance, an avionics system. The onboard computing device(s) 104 can be coupled to a variety of systems on the aircraft 102 over a communications network 115. The communications network 115 can include a data bus or combination of wired and/or wireless communication links.

The onboard computing device(s) 104 can be in communication with a display system 125 including one or more display device(s) that can be configured to display or otherwise provide information generated or received by the system 110 to flight crew members of the aircraft 102. The display system 125 can include a primary flight display, a multipurpose control display unit, or other suitable flight displays commonly included within a cockpit of the aircraft 102. By way of example, the display system 125 can be used for displaying information received from computing system 150 such as a list of potential causes of a failure event and/or recommended solutions associated therewith, as further described herein.

The onboard computing device(s) 104 can also be in communication with a flight control computer 130. The flight control computer 130 can, among other things, automate the tasks of piloting and tracking the flight plan of the aircraft 102. The flight control computer 130 can include or be associated with, any suitable number of individual microprocessors, power supplies, storage devices, interface cards, auto flight systems, flight management computers, and other standard components. The flight control computer 130 can include or cooperate with any number of software programs (e.g., flight management programs) or instructions designed to carry out the various methods, process tasks, calculations, and control/display functions necessary for operation of the aircraft 102. The flight control computer 130 is illustrated as being separate from the onboard computing device(s) 104. Those of ordinary skill in the art, using the disclosures provided herein, will understand that the flight control computer 130 can also be included with or implemented by the onboard computing device(s) 104.

The onboard computing device(s) 104 can also be in communication with one or more aircraft control system(s) 140. The aircraft control system(s) 140 can be configured to perform various aircraft operations and control various settings and parameters associated with the aircraft 102. For instance, the aircraft control system(s) 140 can be associated with one or more engine(s) 120 and/or other components of the aircraft 102. The aircraft control system(s) 140 can include, for instance, digital control systems, throttle systems, inertial reference systems, flight instrument systems, engine control systems, auxiliary power systems, fuel monitoring systems, engine vibration monitoring systems, communications systems, flap control systems, flight data acquisition systems, and other systems.

The aircraft control system(s) 140 can provide one or more operating condition(s) to the onboard computing device(s) 104, for example, for use in detecting a failure event associated with one more component(s) of the aircraft 102 while in flight. For instance, the aircraft control system(s) 140 can provide engine operating condition(s) to the onboard computing device(s) 104 for use in determining an operating state of the engine(s) 120. Engine operating condition(s) can include information such as, for example, engine mode data, engine health data, atmospheric data, throttle information, fuel flow, fuel consumption, and/or other information. The onboard computing device(s) 104 can be configured to detect a failure event (e.g., an engine malfunction) associated with the engine(s) 120 of aircraft 102 based, at least in part, on the engine operating condition(s). As further described herein, the aircraft control system(s) 140 can be configured to receive one or more command signal(s) from the onboard computing device(s) 104 to implement a control action (e.g., to alleviate a failure event).

The onboard computing device(s) 104 can be configured to send and/or receive data from the computing system 150 while the aircraft 102 is in flight. For instance, the onboard computing device(s) 104 can be configured to send a first set of data to the computing system 150 while the aircraft 102 is in flight. The first set of data can include, for example, one or more condition(s) associated with the aircraft 102 during the failure event (e.g., an engine malfunction). The onboard computing device(s) 104 can be configured to receive a second set of data from the computing system 150. The second set of data can include one or more potential cause(s) of at least a portion of the failure event, as further described herein.

The computing system 150 can be, for instance, a ground-based computing system and can include one or more computing device(s) 155. The computing device(s) 155 can be remote from the onboard computing device(s) 104 of aircraft 102. Moreover, the computing device(s) 155 can include one or more processor(s) and one or more memory device(s). The processing architecture associated with the computing device(s) 155 can be different from the processing architecture associated with the onboard computing device(s) 104. The computing device(s) 155 can include a massively parallel server, workstation, and/or supercomputer based system with multiple parallel processing nodes (e.g., each containing a microprocessor) that is configured to perform a set of coordinated computations (e.g., simulation(s) of aircraft failure events). The computing device(s) 155 can include a hardware gate-array based simulation engine.

For instance, the computing device(s) 155 can be configured to receive data from the aircraft 102 and perform one or more simulation(s) based on the data. The computing device(s) 155 can receive, from the aircraft 102 (while in flight), a first set of data indicative of at least one or more condition(s) associated with the aircraft 102 during a failure event such as, for example, a malfunction of the engine(s) 120. The computing device(s) 155 can be configured to perform simulation(s) to create one or more simulated failure event(s) based, at least in part, on the condition(s) associated with the aircraft 102, as further described herein. For instance, the computing device(s) 155 can be configured to perform one or more simulation(s) to simulate a malfunction of the engine(s) 120 based, at least in part, on the condition(s) associated with the engine(s) 120.

The computing device(s) 155 can be configured to determine one or more potential cause(s) of at least a portion of the failure event. The potential cause(s) can be based at least in part on the one or more simulated failure event(s). For instance, based on the simulated engine malfunction, the computing device(s) 155 can determine that the actual malfunction of the engine(s) 120 may have been caused by low oil pressure, high oil temperature, a compressor surge, etc. The computing device(s) 155 can be configured to determine one or more probability value(s) for each of the one or more potential cause(s). The probability value(s) can, for example, be indicative of a probability and/or likeliness that the potential cause is an actual cause of the failure event (e.g., engine malfunction).

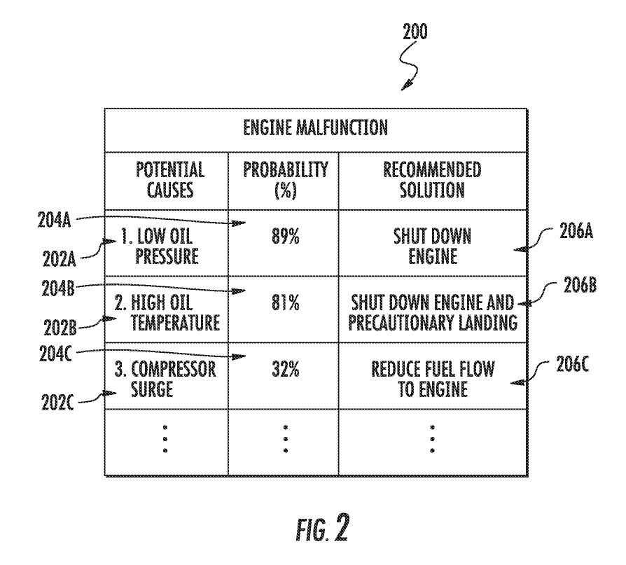

The computing device(s) 155 can also be configured to determine one or more recommended solution(s) for each of the one or more potential cause(s) of the failure event. Each of the recommended solutions can include a proposed course of action to alleviate at least a portion of the failure event. For instance, in the case of a malfunction of that engine(s) 120, the recommended solution(s) can include shutting down the engine(s) 120, a precautionary landing, reducing fuel flow to the engine(s) 120, etc. In some implementations, the computing device(s) 155 can be configured to generate a list of the potential cause(s) of the failure event, the probability value(s) associated therewith, and/or the recommended solution(s), as further described herein with respect to FIG. 2.

The computing device(s) 155 can be configured to communicate data to the aircraft 102. For instance, the computing device(s) 155 can be configured to communicate a second set of data to the aircraft 102, while the aircraft 102 is in flight. The second set of data can be indicative of at least the potential cause(s) of at least a portion of the failure event. Additionally, and/or alternatively, the second set of data can be indicative of at least the one or more recommended solution(s) for each of the one or more potential cause(s) of the failure event. For instance, in some implementations, the second set of data can include the list of the potential cause(s), probability value(s), and/or recommended solution(s).

The onboard computing device(s) 104 of aircraft 102 can be configured to receive the second set of data while in flight. In some implementations, the second set of data can be configured to be processed by the aircraft 102 to implement the proposed course of action (associated with the recommended solution(s)) to alleviate at least a portion of the failure event while in flight. The onboard computing device(s) 104 can be configured to send one or more command signal(s) to the aircraft control system(s) 140 to execute a control action to implement at least one of the recommended solution(s). The command signal(s) can be sent automatically, without user input (e.g., from a flight crew member), and/or based, at least in part, on user input.

By way of example, the second set of data can indicate that a potential cause of a malfunction associated with the engine(s) 120 is a compressor surge and that a recommended solution is to reduce fuel flow to the engine(s) 120. In response, the onboard computing device(s) 104 can send one or more command signal(s) to the aircraft control system(s) 140 to reduce fuel flow to the engine(s) 120.

Additionally and/or alternatively, the onboard computing device(s) 155 can be configured to communicate with the display system 125 to display the one or more potential cause(s) of the failure event, probability value(s) and/or the one or more recommended solution(s) for each of the one or more potential cause(s) of the failure event. For instance, a list of potential cause(s), probability value(s), and/or recommended solution(s) can be displayed on display system 125 while in flight.

FIG. 2 depicts an example list 200 according to example embodiments of the present disclosure. As indicated above, the computing device(s) 155 can be configured to generate the list 200 based on the one or more simulation(s) performed by the computing device(s) 155. The list 200 can be included in data sent from the computing device(s) 155 to the onboard computing device(s) 104 and/or displayed on the display system 125.

For instance, the list 200 can include one or more potential cause(s) 202A-C of at least a portion of the failure event. For instance, if at least a portion of the failure event includes a malfunction of the engine(s) 120, the potential cause(s) of the malfunction can include: potential cause 202A (e.g., low oil pressure), potential cause 202B (e.g., high oil temperature), and/or potential cause 202C (e.g., compressor surge).

In some implementations, the list can include one or more probability value(s) 204A-C for each of the potential cause(s) 202A-C. The probability value(s) can be indicative of a probability and/or likeliness that the potential cause is an actual cause of the failure event. The list 200 can indicate the probability value(s) by a percentage, a fraction, a color, text, font, graphical element, an order of the potential cause(s) 202A-C, and/or any other approach to indicate the likeliness of the potential cause(s) 202A-C. For example, as shown in FIG. 2, the potential cause 202A (e.g., low oil pressure) can be associated with a probability value 204A of 89%, the potential cause 202B can be associated with a probability value 204B of 81%, and the potential cause 202C can be associated with a probability value 204C of 32%. In some implementations, the one or more potential cause(s) 202A-C can be organized based at least in part on the probability value 204A-C associated with each of the potential cause(s) 202A-C.

Additionally, and/or alternatively, the list 200 can include one or more recommended solution(s) 206A-C for each of the potential cause(s) 202A-C. Each recommended solution can include a proposed course of action to alleviate at least a portion of the failure event. For example, the potential cause 202A (e.g., low oil pressure) can be associated with a recommended solution 206A (e.g., shut down the engine(s) 120), the potential cause 202B (e.g., high oil temperature) can be associated with a recommended solution 206B (e.g., shut down the engine(s) 120 and perform a precautionary landing), and the potential cause 202C (e.g., compressor surge) can be associated with a recommended solution 206C (e.g., reduce fuel flow to the engine(s) 120).

Three potential cause(s) 202A-C, probability value(s) 204A-C, and recommended solution(s) 206A-C are depicted in FIG. 2 for purposes of illustration and discussion. Those of ordinary skill in the art, using the disclosures provided herein, will understand that more or fewer potential cause(s), probability value(s), and recommended solution(s) can be used without deviations from the scope of the present disclosure.

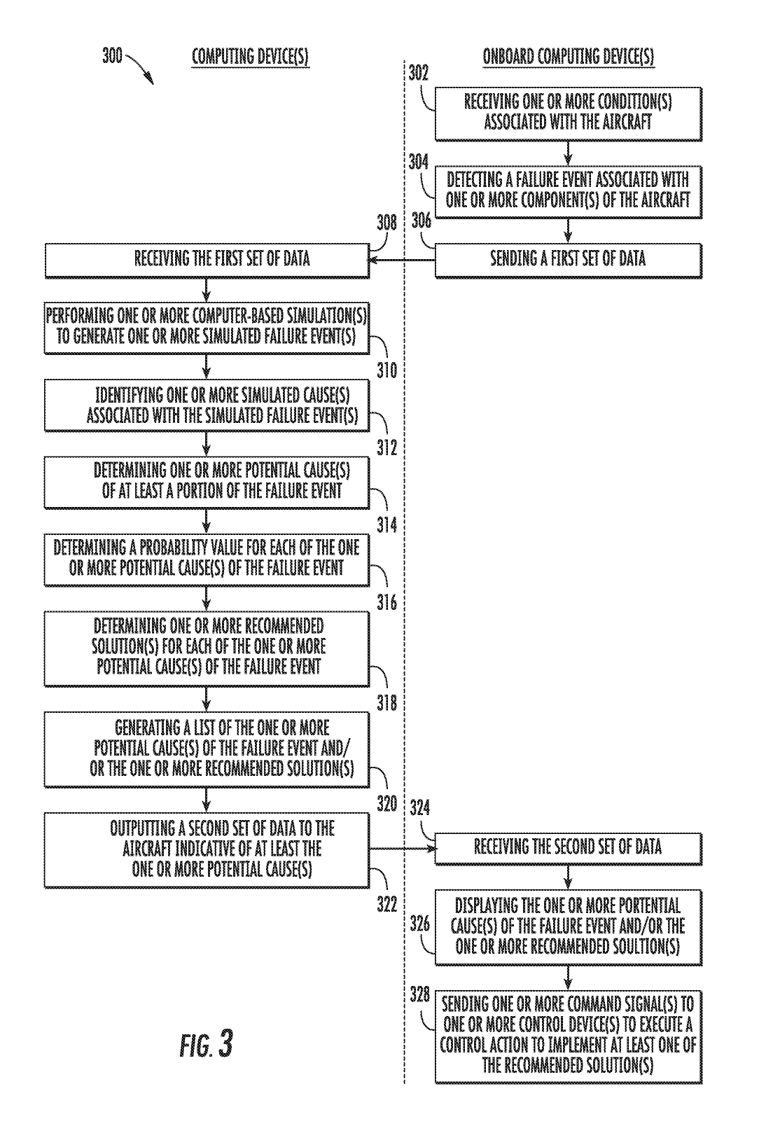

FIG. 3 depicts a flow diagram of an example method 300 of diagnosing aircraft failure according to example embodiments of the present disclosure. FIG. 3 can be implemented by one or more computing device(s), such as the onboard computing device(s) 104 and/or the computing device(s) 155 depicted in FIGS. 1 and 6. One or more step(s) of the method 300 can be performed while aircraft 102 is in-flight. In addition, FIG. 3 depicts steps performed in a particular order for purposes of illustration and discussion. Those of ordinary skill in the art, using the disclosures provided herein, will understand that the various steps of any of the methods disclosed herein can be modified, adapted, expanded, rearranged and/or omitted in various ways without deviating from the scope of the present disclosure.

At (302), the method 300 can include receiving one or more condition(s) associated with the aircraft. For instance, the onboard computing device(s) 104 of aircraft 102 can receive one or more condition(s) associated with various components from the aircraft control system(s) 140 while in flight. For example, the onboard computing device(s) 104 can receive one or more condition(s) associated with the engine(s) 120. The condition(s) can include, for example, engine mode data, engine health data, fuel flow, fuel consumption, and/or other information during and/or before a malfunction of the engine(s) 120.

At (304), the method 300 can include detecting a failure event associated with one or more component(s) of the aircraft. For instance, the onboard computing device(s) 104 can detect a failure event associated with the aircraft 102 based, at least in part, on the condition(s) sent from the aircraft control system(s) 140, while the aircraft 102 is in flight. In one example, the onboard computing device(s) 104 can detect a malfunction of the engine(s) 120 based, at least in part, on the operating condition(s) of engine(s) 120.

At (306), the method 300 can include sending a first set of data to one or more computing device(s) that are remote from the aircraft while in flight. For instance, the onboard computing device(s) 104 can send a first set of data to the computing device(s) 155, which can be remote from the aircraft 102. The first set of data can be indicative a failure event associated with the aircraft 102 and/or indicative of one or more condition(s) associated with the aircraft 102 during the failure event. The first set of data can include the condition(s) sent to the onboard computing device(s) 104 from the aircraft control system(s) 140 and/or other conditions associated with one or more component(s) of the aircraft 102. For example, the first set of data can be indicative of condition(s) associated with the engine(s) 120.

At (308), the method 300 can include receiving the first set of data from the aircraft (while in flight), that detected the failure event associated with the aircraft. For instance, the computing device(s) 155 can receive the first set of data from the onboard computing device(s) 104, which detected the failure event associated with the aircraft 102.

At (310), the method 300 can include performing one or more computer-based simulation(s) to generate one or more simulated failure event(s). For instance, the computing devices 155 can perform one or more computer-based simulation(s) to generate one or more simulated failure event(s). The one or more simulated failure event(s) can be based, at least in part, on the one or more condition(s) associated with the aircraft 102 and/or its components during the failure event.

The computing device(s) 155 can use one or more function(s), algorithm(s), model(s), equation(s), etc. to simulate the operation of the aircraft 102 and/or its components. The computing device(s) 155 can include the condition(s) associated with the aircraft 102 in the simulation to create one or more simulated failure event(s). The computing device(s) 155 can also make assumptions (e.g., about the operation of aircraft 102) during the performance of the simulation(s).

By way of example, as indicated above, the processing architecture associated with the computing device(s) 155 can include one or more parallel processing architectures configured to generate one or more simulated failure events. This can help increase the processing time and accuracy of failure diagnosis. Moreover, the processing architecture associated with the computing device(s) 155 can better isolate the fault of a potential cause. For example, the computing device(s) 155 can better determine that the potential cause 202A (e.g., low oil pressure) is indicative of a true loss of pressure, not merely a sensor failure.

The computing device(s) 155 can perform one or more simulation(s), using its parallel processing architecture, to create one or more simulated failure event(s) which represent possible malfunctions of the engine(s) 120. The simulated failure event(s) can be based, at least in part, on engine mode data, engine health data, fuel flow, fuel consumption, etc. included in the first set of data.

Additionally, and/or alternatively, the computing devices 155 can perform one or more computer-based simulation(s) to generate one or more simulated failure event(s) based, at least in part, on an aggregate set of data. For instance, the aggregate set of data can include a plurality of conditions associated with a plurality of other aircrafts that have each experienced separate failure events. The computing devices 155 can receive the aggregate set of data and/or create the aggregate set of data overtime as it performs simulations for different aircrafts. In this way, the one or more simulations can be based, at least in part, on a plurality of conditions associated with a plurality other aircrafts during separate failure events.

At (312), the method 300 can include identifying one or more simulated cause(s) associated with the simulated failure event(s). For instance, the computing device(s) 155 can identify one or more simulated cause(s) associated with each of the one or more simulated failure event(s). For example, during and/or after performing the simulation(s), the computing device(s) 155 can identify any simulated cause(s) that could have led to one or more of the simulated malfunction of the engine(s) 120.

At (314), the method 300 can include determining one or more potential cause(s) of at least a portion of the failure event. The computing device(s) 155 can determine one or more potential cause(s) of at least a portion of the failure event, based at least in part, on the simulated cause(s) associated with the simulated failure event(s). For instance, the computing device(s) 155 can examine the simulated failure event(s) and identify which of the simulated failure event(s) best fit and/or match the one or more condition(s) included in the first set of data received from the aircraft 102. The simulated cause(s) associated with the best fitting and/or matching simulated failure event(s) can be determined as the one or more potential cause(s) of at least a portion of the failure event.

For example, the computing device(s) 155 can identify which of the simulated engine malfunction(s) best fit and/or match the one or more condition(s) associated with the engine(s) 120 during the malfunction. In one example, the best fitting simulated engine malfunction(s) can have three simulated causes: low oil pressure, high oil temperature, and/or a compressor surge. Accordingly, the computing device(s) 155 can determine that the potential cause(s) 202A-C of at least a portion of the malfunction of the engine(s) 120 can be attributed to low oil pressure, high oil temperature, and/or a compressor surge.

At (316), the method 300 can include determining one or more probability value(s) for each of the one or more potential cause(s) of the failure event. For instance, the computing device(s) 155 can determine one or more probability value(s) for each of the one or more potential cause(s) of the failure event. As indicated above, the probability value(s) can be indicative of a probability and/or likeliness that the potential cause is an actual cause of the failure event. In some implementations, the probability value(s) can be based, at least in part, on the fit of the simulated failure event to the one or more condition(s) included in the first set of data.

By way of example, the computing device(s) 155 can determine one or more probability value(s) 204A-C for each of the one or more potential cause(s) 202A-C. For instance, the computing device(s) 155 can determine that there is a 89% likelihood that potential cause 202A (e.g., low oil pressure) is an actual cause of the engine malfunction, that there is an 81% likelihood that potential cause 202B is an actual cause of the engine malfunction, and/or that there is a 32% likelihood that potential cause 202C is an actual cause of the engine malfunction.

At (318), the method 300 can include determining one or more recommended solution(s) for each of the one or more potential cause(s) of the failure event. For instance, the computing device(s) 155 can determine one or more recommended solution(s) for each of the one or more potential cause(s) of the failure event. Each of the recommended solution(s) can include a proposed course of action to alleviate at least a portion of the failure event.

For example, computing device(s) 155 can determine the recommended solution(s) 206A-C for each of the potential cause(s) 202A-C of the malfunction of the engine(s) 120. For potential cause 202A (e.g., low oil pressure), the computing device(s) 155 can recommend solution 206A, shutting down the engine(s) 120. For potential cause 202B (e.g., high oil temperature), the computing device(s) 155 can recommend solution 206B, shutting down the engine(s) 120 and performing a precautionary landing. For potential cause 202C (e.g., compressor surge), the computing device(s) 155 can recommend solution 206C, reducing fuel flow to the engine(s) 120.

At (320), the method 300 can include generating a list of the one or more potential cause(s) of the failure event and/or the one or more recommended solution(s). For instance, the computing device(s) 155 can generate list 200 as described above with reference to FIG. 2.

At (322), the method 300 can include communicating a second set of data to the aircraft indicative of at least the one or more potential cause(s) of at least a portion of the failure event. For instance, the computing device(s) 155 can communicate a second set of data to the onboard computing device(s) 104 of aircraft 102 while the aircraft 102 is in flight.

The second set of data can be indicative of at least the one or more potential cause(s) of at least a portion of the failure event. Additionally and/or alternatively, the second set of data can be indicative of the probability value(s) and/or the one or more recommended solution(s) for each of the one or more potential cause(s) of the failure event. In some implementations, the second set of data can include a list of the one or more potential cause(s) of the failure event. For example, the second set of data can be indicative of potential cause(s) 202A-C, probability value(s) 204A-C, and/or recommended solution(s) 202A-C in the event of a malfunction of the engine(s) 120. In some implementations, the second set of data can include the list 200, which can be organized based, at least in part, on the probability value(s) 204A-C for each of the potential cause(s) 202A-C, as shown in FIG. 2.

At (324), the method 300 can include receiving the second set of data. For instance, the onboard computing device(s) 104 can receive the second set of data from the computing device(s) 155 while the aircraft 102 is in flight.

At (326), the method 300 can include displaying the one or more potential cause(s) of the failure event and/or the one or more recommended solution(s). For instance, the onboard computing device(s) 104 can communicate with the display system 125 to display (e.g., while in flight) the one or more potential cause(s) 202A-C of the failure event (e.g., malfunction of the engine(s) 120), the probability value(s) 204A-C, and/or the one or more recommended solution(s) 206A-C. In some implementations, the onboard computing device(s) 104 can communicate with the display system 125 to display the list 200.

At (328), the method 300 can include sending one or more command signal(s) to one or more aircraft control systems(s) to execute a control action. For instance, the onboard computing device(s) 104 can send one or more command signal(s) to the one or more aircraft control system(s) 140 to execute a control action to implement at least one of the recommended solution(s) 206A-C, while the aircraft 102 is in flight. For example, the onboard computing device(s) 104 can send a command signal to the aircraft control system(s) 140 associated with the engine(s) 120 to shut down the engine(s) 120 and/or to reduce the fuel flow to the engine(s) 120. Additionally, and/or alternatively, the onboard computing device(s) 104 can communicate with the flight control computer 130 in the event a precautionary landing is recommended.

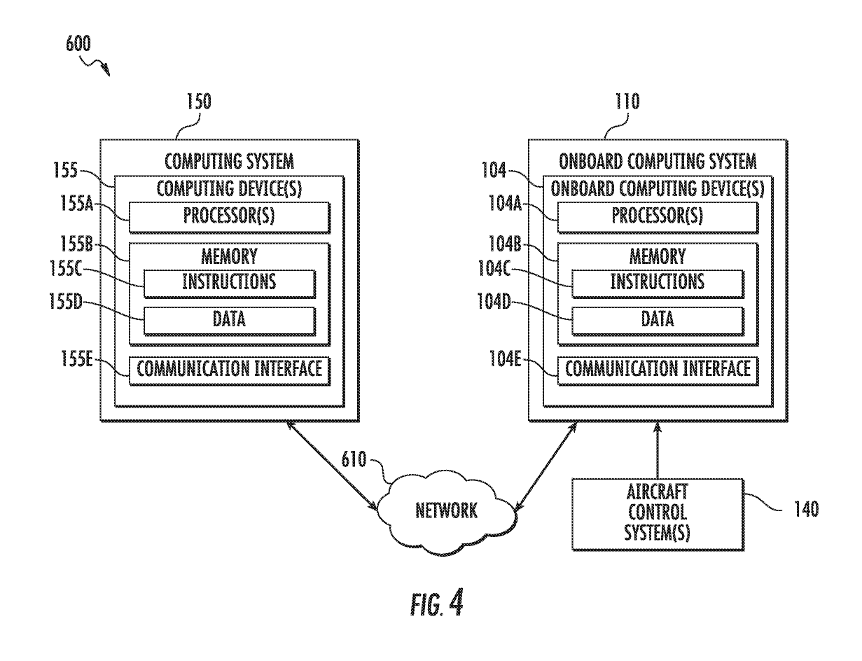

FIG. 4 depicts an example system 600 according to example embodiments of the present disclosure. The system 600 can include the onboard computing system 110 and the computing system 150. Computing system 150 can be located at remote location that is separated and remote from the onboard computing system 110 located onboard the aircraft 102. The onboard computing system 110 and the computing system 150 can be configured to communicate via a network 610, such as, a very high frequency (VHF) network, high frequency (HF) network, SATCOM network, WiFi, network and/or any other suitable communication networks.

As shown, the onboard computing system 110 can include onboard computing device(s) 104. The onboard computing device(s) 104 can include one or more processor(s) 104A and one or more memory device(s) 104B. The one or more processor(s) 104A can include any suitable processing device, such as a microprocessor, microcontroller, integrated circuit, logic device, or other suitable processing device. The one or more memory device(s) 104B can include one or more computer-readable media, including, but not limited to, non-transitory computer-readable media, RAM, ROM, hard drives, flash drives, or other memory devices.

The one or more memory device(s) 104B can store information accessible by the one or more processor(s) 104A, including computer-readable instructions 104C that can be executed by the one or more processor(s) 104A. The instructions 104C can be any set of instructions that when executed by the one or more processor(s) 104A, cause the one or more processor(s) 104A to perform operations. The instructions 104C can be software written in any suitable programming language or can be implemented in hardware. In some embodiments, the instructions 104C can be executed by the one or more processor(s) 104A to cause the one or more processor(s) 104A to perform operations, such as the operations for addressing aircraft failure as described with reference to FIG. 3, the operations for sending command signals to aircraft control system(s) 140, and/or any other operations or functions of the one or more onboard computing device(s) 104.

The memory device(s) 104B can further store data 104D that can be accessed by the processors 104A. For example, the data 104D can include one or more operating condition(s) associated with the aircraft 102 and/or its components. The data 104D can also include data associated with the aircraft control system(s) 140, one or more potential cause(s) of a failure event, one or more probability value(s) associated with the potential cause(s), and/or one or more recommended solution(s) for the potential cause(s).

The onboard computing device(s) 104 can also include a network interface 104E used to communicate, for example, with the other components of system 600. The network interface 104E can include any suitable components for interfacing with one more network(s), including for example, transmitters, receivers, ports, controllers, antennas, or other suitable components.

The computing system 150 can include one or more computing device(s) 155. The one or more computing device(s) 155 can include one or more processor(s) 155A and one or more memory device(s) 155B. As indicated above, the processor(s) 155A can include massively parallel servers and/or supercomputers with multiple nodes (e.g., each containing a microprocessor) that are configured to perform a set of coordinated computations (e.g., simulation(s) of aircraft failure events). For example, the processors 155A can include a massively parallel, RS/6000 SP Thin P2SC-based system with multiple nodes, each node containing a 120 MHz P2SC microprocessor. The one or more processor(s) 155A can also include any other suitable processing device, microprocessor, microcontroller, integrated circuit, logic device, etc.

The one or more memory device(s) 155B can store computer-readable instructions 155C that when executed by the one or more processor(s) 155A cause the one or more processor(s) 155A to perform operations, such as the operations for diagnosing aircraft failure as described with reference to FIG. 3, and/or any other operations or functions of the one or more computing device(s) 155. For instance, the instructions 155C can be implemented by the one or more processor(s) 155A to perform simulations as described herein. The memory device(s) 155B can further store data 155D. The data 155D can include, for instance, one or more function(s), algorithm(s), model(s), equation(s), etc. to simulate the operation of the aircraft 102 and/or its components. The data 155D can also include data associated with the aircraft 102, such as data indicative of one or more condition(s) of the aircraft 102 before, during, and/or after a failure event.

The computing device(s) 155 can also include a network interface 155E used to communicate, for example, with the other components of system 600 over network 610. The network interface 155E can include any suitable components for interfacing with one or more network(s), including for example, transmitters, receivers, ports, controllers, antennas, or other suitable components.

The technology discussed herein makes computer-based systems and actions taken by and information sent to and from computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Although specific features of various embodiments may be shown in some drawings and not in others, this is for convenience only. In accordance with the principles of the present disclosure, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and can include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A computer-implemented method of diagnosing aircraft failure, comprising:
receiving, by one or more computing devices, a first set of data from an aircraft in flight indicative of a failure event associated with the aircraft, wherein the first set of data is indicative of at least one or more conditions associated with the aircraft during the failure event, and wherein the one or more computing devices are remote from the aircraft;
performing, by the one or more computing devices, one or more computer-based simulations to generate one or more simulated failure events, wherein the one or more simulated failure events are based at least in part on the one or more conditions associated with the aircraft during the failure event;
identifying, by the one or more computing devices, one or more simulated causes associated with the simulated failure events;
determining, by the one or more computing devices, one or more potential causes of at least a portion of the failure event, based at least in part on the one or more simulated causes associated with the one or more simulated failure events; and
communicating, by the one or more computing devices, a second set of data to the aircraft while the aircraft is in flight, wherein the second set of data is indicative of at least the one or more potential causes of at least the portion of the failure event.

2. The computer-implemented method of claim 1, wherein the one or more computing devices has a first processing architecture that is different from a second processing architecture associated with one or more onboard computing devices associated with the aircraft, and wherein the first processing architecture comprises one or more parallel processing nodes configured to generate the one or more simulated failure events.

3. The computer-implemented method of claim 1, wherein the one or more simulations are based at least in part on a plurality of conditions associated with a plurality other aircrafts during separate failure events.

4. The computer-implemented method of claim 1, further comprising:
determining, by the one or more computing devices, a probability value for each of the one or more potential causes of the failure event, wherein the probability value is indicative of a probability that the potential cause is an actual cause of the failure event.

5. The computer-implemented method of claim 4, further comprising:
generating, by the one or more computing devices, a list of the one or more potential causes of the failure event, wherein the list of the one or more potential causes is organized based at least in part on the probability value for each of the one or more potential causes.

6. The computer-implemented method of claim 5, wherein the second set of data comprises the list of the one or more potential causes of the failure event.

7. The computer-implemented method of claim 1, further comprising:
determining, by the one or more computing devices, one or more recommended solutions for each of the one or more potential causes of the failure event, wherein each of the recommended solutions includes a proposed course of action to alleviate at least a portion of the failure event.

8. The computer-implemented method of claim 7, wherein the second set of data is indicative of the one or more recommended solutions for each of the one or more potential causes of the failure event.

9. The computer-implemented method of claim 1, wherein the one or more conditions of the aircraft are associated with one or more components of the aircraft, and wherein the one or more computer-based simulations are based at least in part on simulating failure of the one or more components.

10. A ground-based system for diagnosing aircraft failure, comprising:
one or more processors; and
one or more memory devices storing computer-readable instructions that when executed by the one or more processors cause the system to perform operations, the operations comprising:
receiving a first set of data from an aircraft in flight, wherein the first set of data is indicative of at least one or more conditions associated with the aircraft during a failure event;
performing one or more simulations to create one or more simulated failure events, wherein the one or more simulated failure events are based at least in part on the one or more conditions associated with the aircraft during the failure event;
determining one or more potential causes of at least a portion of the failure event, wherein the one or more potential causes are based at least in part on the one or more simulated failure events; and
communicating a second set of data to the aircraft while the aircraft is in flight, wherein the second set of data is indicative of at least the one or more potential causes of at least a portion of the failure event.

11. The ground-based system of claim 10, wherein the operations further comprise:
generating a list of the one or more potential causes of the failure event, wherein the list of the one or more potential causes is organized based at least in part on a probability associated with each of the one or more potential causes, wherein the probability is indicative of the likeliness that the potential cause is an actual cause of the failure event, and
wherein the second set of data comprises the list of the one or more potential causes of the failure event.

12. The ground-based system of claim 10, wherein the operations further comprise:
determining one or more recommended solutions for each of the one or more potential causes of the failure event, wherein each of the recommended solutions includes a proposed course of action to alleviate at least a portion of the failure event.

13. The ground-based system of claim 12, wherein the second set of data is indicative of at least the one or more recommended solutions for each of the one or more potential causes of the failure event.

14. The ground-based system of claim 13, wherein the second set of data is configured to be processed by the aircraft to implement the proposed course of action to alleviate at least the portion of the failure event.

15. A computer-implemented method for addressing aircraft failure, comprising:
detecting, by one or more first computing devices located on an aircraft in flight, a failure event associated with one or more components of the aircraft;
sending, by the one or more first computing devices, a first set of data to one or more second computing devices that are remote from the aircraft, wherein the first set of data comprises one or more conditions associated with the aircraft during the failure event, wherein the one or more second computing devices are configured to perform one or more simulations to generate one or more simulated failure events based at least in part on the one or more conditions associated with the aircraft during the failure event; and
receiving, by the one or more first computing devices while the aircraft is in flight, a second set of data from the one or more second computing devices, wherein the second set of data comprises one or more potential causes of at least a portion of the failure event, and wherein the one or more potential causes are based at least in part on one or more simulated causes associated with the one or more simulated failure events.

16. The computer-implemented method of claim 15, wherein the second set of data further comprises a probability value for each of the one or more potential causes of the failure event, wherein the probability value is indicative of a probability that the potential cause is an actual cause of the failure event.

17. The computer-implemented method of claim 16, wherein the second set of data further comprises a list of the one or more potential causes of the failure event, wherein the list of the one or more potential causes is organized based at least in part on the probability value for each of the one or more potential causes.

18. The computer-implemented method of claim 15, wherein the second set of data further comprises one or more recommended solutions for each of the one or more potential causes of the failure event, wherein each of the one or more recommended solutions includes a proposed course of action to alleviate at least a portion of the failure event.

19. The computer-implemented method of claim 18, further comprising:
displaying, by the one or more first computing devices, the one or more potential causes of the failure event and the one or more recommended solutions for each of the one or more potential causes of the failure event.

20. The computer-implemented method of claim 18, further comprising:
sending, by the one or more first computing devices, one or more command signals to one or more aircraft control systems to execute a control action to implement at least one of the recommended solutions.
